(19) United States
(12) Patent Application Publication
(10) Pub. No.: US 2024/0352752 A1
(43) Pub. Date: Oct. 24, 2024

(54) CONCRETE VIBRATOR

(71) Applicant: MILWAUKEE ELECTRIC TOOL CORPORATION, Brookfield, WI (US)

(72) Inventors: Collin C. Rink, Milwaukee, WI (US); Jacob R. McDonald, Ixonia, WI (US); John L. O’Sullivan, Milwaukee, WI (US); Carmen J. Castanos, Milwaukee, WI (US); Erik A. Freeberg, Oconomowoc, WI (US); Terry L. Timmons, Oconomowoc, WI (US)

(21) Appl. No.: 18/686,103

(22) PCT Filed: Nov. 8, 2022
(86) PCT No.: PCT/US2022/049260

§ 371 Date: Feb. 23, 2024

Related U.S. Application Data
(60) Provisional application No. 63/276,719, filed on Nov. 8, 2021.

(51) Int. Cl. E04G 21/08; B25F 5/00

(52) U.S. Cl. CPC E04G 21/08; B25F 5/001

(57) ABSTRACT

A concrete vibrator includes a housing having a motor housing portion extending along a longitudinal axis and a handle portion extending transverse to the longitudinal axis and spaced from the motor housing portion, defining an opening between the handle portion and the motor housing portion. The concrete vibrator also includes a trigger, a brushless DC electric motor positioned within the motor housing portion, a battery pack configured to provide electrical power to the electric motor to drive the motor, and an electronic processor electrically connected with the motor and the battery pack. The electronic processor is configured to adjust the electrical power to the motor in a closed loop to maintain operation of the motor at a rotational speed set point. The concrete vibrator also includes a vibrator head configured to receive torque from the motor, causing the vibrator head to vibrate.

### CROSS-REFERENCE TO RELATED APPLICATIONS

This application claims priority to co-pending U.S. Provisional Application No. 63/276,719 filed on Nov. 8, 2021, the entire content of which is incorporated herein by reference.

### FIELD OF THE INVENTION

The present invention relates to power tools, and more particularly to concrete vibrators.

### BACKGROUND OF THE INVENTION

Concrete vibrators are typically used to spread poured concrete around a framework, such as rebar, in a construction operation. Such concrete vibrators are typically powered by an internal combustion engine, which can be difficult to carry by an operator using the concrete vibrator while on a worksite.

### SUMMARY OF THE INVENTION

The invention provides, in one aspect, a concrete vibrator including a housing having a motor housing portion extending along a longitudinal axis and a handle portion extending transverse to the longitudinal axis and spaced from the motor housing portion, defining an opening between the handle portion and the motor housing portion. The concrete vibrator also includes a trigger located within the opening rearward of the motor housing portion, and extending from the handle portion of the housing, a brushless DC electric motor positioned within the motor housing portion, a battery pack configured to provide electrical power to the electric motor to drive the motor, and an electronic processor electrically connected with the motor and the battery pack. The electronic processor is configured to adjust the electrical power to the motor in a closed loop to maintain operation of the motor at a rotational speed set point. The concrete vibrator also includes a vibrator head configured to receive torque from the motor to cause the vibrator head to vibrate.

The invention provides, in another independent aspect, a housing including a motor housing portion, a motor positioned within the motor housing portion, a power source configured to provide power to the motor, and a whip assembly. The whip assembly is coupled at one end to the motor and at an opposite end to a vibrator head configured to receive torque from the motor through the whip assembly and cause the vibrator head to vibrate, the whip assembly including a flexible shaft coupled to the motor, a sheath surrounding the shaft, and means to inhibit deflection of the flexible shaft within the sheath.

The invention provides, in another aspect, a method of operating a concrete vibrator. The method includes sensing motor feedback indicative of a position, velocity, or acceleration of a rotor of an electric motor, outputting a signal indicative of the motor feedback information to an electronic processor. The method further includes, based on the motor feedback information, transmitting by the electronic processor and via closed loop control, electrical current to the motor to maintain operation of the motor at a rotational speed set point. The method also includes transmitting torque from the motor to a vibrator head of the concrete vibrator to cause the vibrator head to vibrate.

Other features and aspects of the invention will become apparent by consideration of the following detailed description and accompanying drawings.

### BRIEF DESCRIPTION OF THE DRAWINGS

FIG. 1 is a perspective view of a concrete vibrator in accordance with an embodiment of the invention.

FIG. 2 is a side view of the concrete vibrator of FIG. 1.

FIG. 3 is an enlarged side view of a drive unit of the concrete vibrator of FIG. 1 taken along section line 5-5 in FIG. 2.

FIG. 4 is a cross-sectional view of the drive unit taken along section line 4-4 in FIG. 1.

FIG. 5 is a cross-sectional view of a vibrator head of the concrete vibrator of FIG. 1, taken along section line 5-5 in FIG. 1.

FIG. 6 is an enlarged view of the vibrator head within region 6-6 in FIG. 5.

FIG. 7 is an enlarged view of the vibrator head within region 7-7 in FIG. 5.

FIG. 8 is a simplified block diagram of the concrete vibrator of FIG. 1.

FIG. 9 is a cross-sectional view of a concrete vibrator including an alternate whip assembly.

FIG. 10 is a cross-sectional view of a concrete vibrator including another alternate whip assembly.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

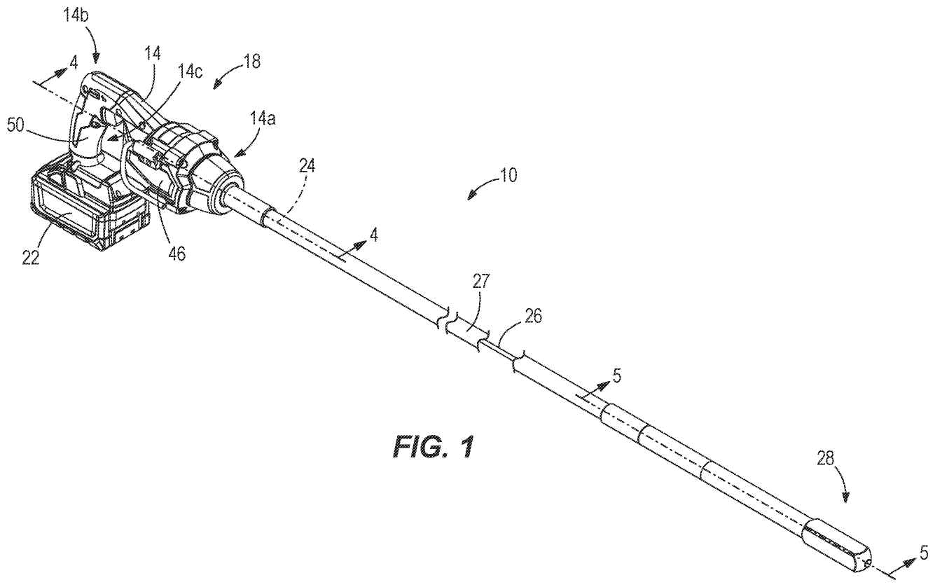

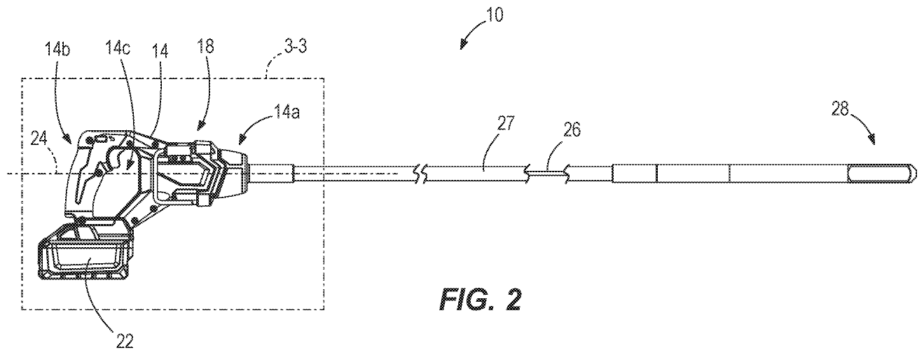

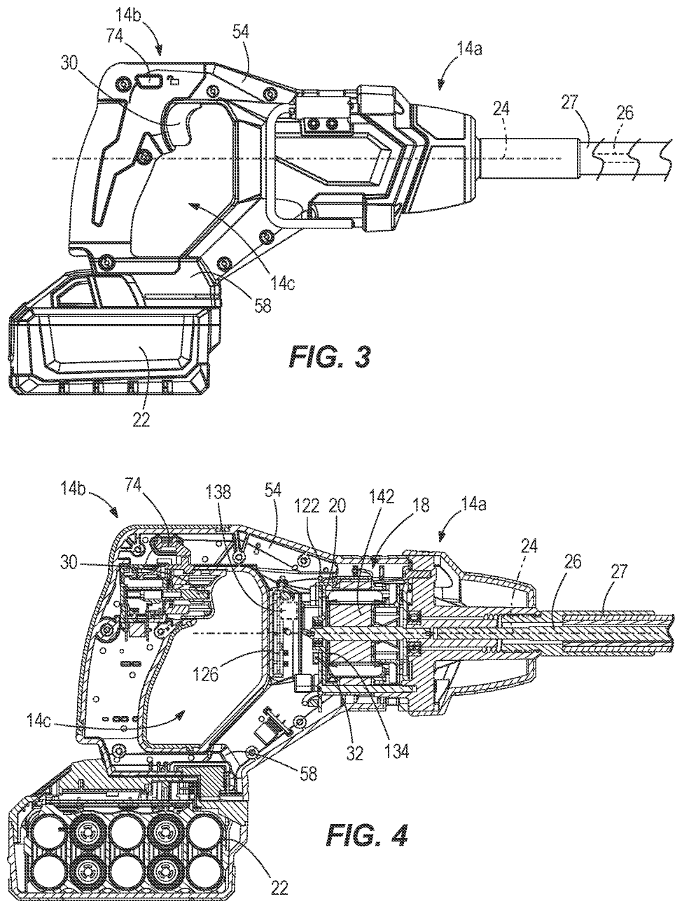

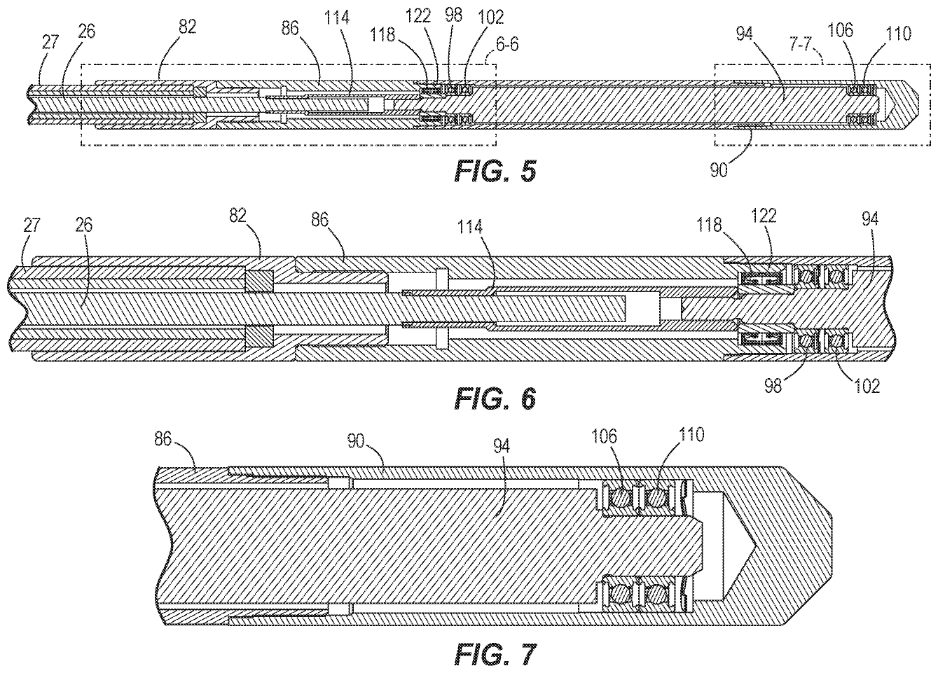

FIGS. 1 and 2 illustrate a concrete vibrator 10 including a housing 14, a power unit (e.g., a brushless direct current electric motor 18) positioned within the housing 14, and a battery pack 22 carried onboard the housing 14 for providing power to the electric motor 18. In some embodiments, the battery pack 22 and the motor 18 can be configured to operate with a nominal voltage of 18 V. With reference to FIG. 3, the housing 14 includes a motor housing portion 14a extending along a longitudinal axis 24 and a handle portion 14b extending transverse to the longitudinal axis 24 and spaced from the motor housing portion 14a, defining an opening 14c between the handle portion 14b and the motor housing portion 14a.

As illustrated in FIG. 3, the handle portion 14b is spaced along the longitudinal axis 24 from the motor housing portion 14a. The handle portion 14b is connected to the motor housing portion 14a by connection portions 54, 58 such that the opening 14c is defined by the housing 14 between the between the connection portions 54, 58, the motor housing portion 14a and the handle portion 14b. In the illustrated embodiment, the connection portions 54, 58 extend from respective ends of the handle portion 14b and in an oblique direction to the longitudinal axis 24 to converge at the motor housing portion 14a. As such, a user may extend a hand through the opening 14c to grasp the handle portion 14b of the concrete vibrator 10.

As illustrated in FIG. 4, the concrete vibrator 10 also includes a flexible shaft 26 extending from the housing 14 and a vibrator head 28 connected to an end of the shaft 26. As explained in further detail below, the shaft 26 receives torque from the motor 18. The torque is transmitted to the vibrator head 28, causing it to vibrate. In the illustrated embodiment, the flexible shaft 26 is received within a sheath 27. In some embodiments, the flexible shaft 26 is cylindrically shaped, and the sheath 27 is annularly shaped. In some embodiments, the flexible shaft 26 and the sheath 27 may be generally circular in cross-sectional shape. In other embodiments, the shaft 26 and/or the sheath 27 may be non-circularly shaped.

With further reference to FIG. 3, the concrete vibrator 10 includes a trigger 30 extending from the handle portion 14b and into the opening 14c to be grasped by the user when grasping the handle portion 14b. The trigger 30 is biased toward an extended position (FIG. 3) in which electrical power is not transmitted to the motor 18, thereby deactivating the motor 18 or maintaining the motor 18 in a deactivated state in which it does not rotate. The trigger 30 is pulled against its bias to transmit electrical power to the motor 18, thereby activating the motor 18 and causing it to rotate at a predetermined speed (e.g., a rotational speed set point).

In some embodiments of the concrete vibrator 10, the trigger 30 may be a variable speed trigger, which permits the motor 18 to rotate at a variable speed depending on the degree to which the trigger 30 is depressed. In some embodiments, the handle portion 14b may be provided with markings (not shown) adjacent the trigger 30 indicative of the speed at which the motor 18 rotates as the trigger 30 is depressed along the longitudinal axis 24. Additionally, or alternatively, the trigger 30 may include (e.g., at least two) discrete or perceptible trigger positions (i.e., coinciding with a detent, a mechanical lock, or block) upon depressing the trigger 30 a certain amount for different motor 18 speeds. In the example trigger 30 including discrete or perceptible trigger positions, the trigger 30 may be movable between a first operating position, in which the motor 18 is driven at a first non-zero desired speed, and a second operating position in which the motor 18 is driven at a second non-zero desired speed different than the first non-zero desired speed.

A single user may operate the concrete vibrator 10. With one hand, the user can grasp the handle portion 14b and use an index finger to depress the trigger 30 and operate the motor 18, thereby causing vibrations in the vibrator head 28. With the other hand, the user can hold either the flexible shaft 26 or the vibrator head 28 to position the vibrator head 28 into wet concrete.

FIGS. 6 and 7 illustrate the vibrator head 28 in detail. Specifically, the vibrator head 28 includes an outer housing having a connection portion 82 on one side of a body portion 86, and a tip portion 90 on the opposite side of the body portion 86. The tip portion 90 and the connection portion 82 are press-fit or otherwise mechanically connected to the body portion 86. The vibrator head 28 also includes an eccentric shaft 94 rotatably supported at opposite ends by respective pairs of radial bearings 98, 102, 106, 110 positioned within the body portion 86. The eccentric shaft 94 receives torque from the flexible shaft 26, causing the eccentric shaft 94 to rotate. The eccentric shaft 94 is configured to vibrate the vibrator head 28 upon receiving torque from the flexible shaft 26.

As shown in FIG. 6, the vibrator head 28 includes a coupling 114 interconnecting the eccentric shaft 94 and the flexible shaft 26. The vibrator head 28 further includes a lip seal 118 located between the coupling 114 and the bearings 98, 102 to inhibit infiltration of wet concrete or other fluids into the body portion 86. A seal retainer 122 is radially disposed between the lip seal 118 and the body portion 86 to retain the radial and longitudinal position of the lip seal 118 relative to the eccentric shaft 94.

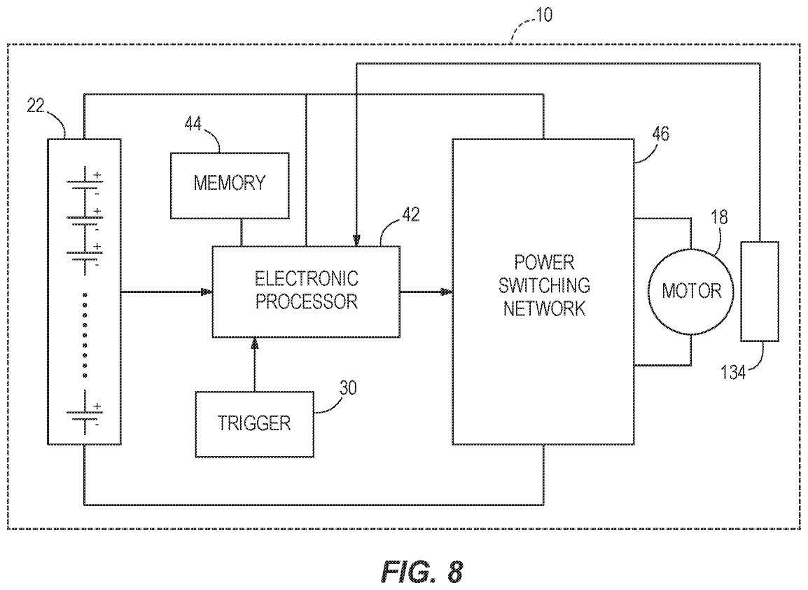

With reference to FIG. 4, the concrete vibrator 10 further includes a power printed circuit board 122 to provide electrical power to the motor 18 and a control printed circuit board 126 to provide control signals to the power printed circuit board 122. The power printed circuit board 122 is mounted to a heat sink 20 on the motor 18 and includes field-effect transistors (FETs) and a rotor position sensor 134 (for example, a Hall-effect sensor array, see FIG. 8).

FIG. 8 is a simplified block diagram of the concrete vibrator 10 according to one example embodiment. In the example illustrated, the concrete vibrator 10 includes an electronic processor 42, a memory 44, the battery pack 22, a power switching network 46 (including the FETs), a rotor position sensor 134, and the trigger 30. In some embodiments, the electronic processor 42 is implemented as a microprocessor with a separate memory (for example, memory 44). In other embodiments, the electronic processor 42 may be implemented as a microcontroller (with memory 64 on the same chip). In other embodiments, the electronic processor 42 may be implemented using multiple processors. In addition, the electronic processor 42 may be implemented partially or entirely as, for example, a field programmable gate array (FPGA), an application specific integrated circuit (ASIC), etc., and the memory 44 may not be needed or modified accordingly. The memory 44 stores instructions executed by the electronic processor 42 to carry out functions of the concrete vibrator 10 described herein. The memory 44 includes read only memory (ROM), random access memory (RAM), other non-transitory computer-readable media, or a combination thereof.

The power switching network 46 enables the electronic processor 42 to control the operation of the motor 18. Generally, when the trigger 30 is depressed, electrical current is supplied from the battery pack 22 to the motor 18, via the power switching network 46. When the trigger 30 is not depressed, electrical current is not supplied from the battery pack 22 to the motor 18. In some embodiments, the amount in which the trigger 30 is depressed is related to or corresponds to a desired speed of rotation of the motor 18 (that is, closed loop speed control). In other embodiments, the amount in which the trigger 30 is depressed is related to or corresponds to a desired torque (that is, open loop speed control).

In response to the electronic processor 42 receiving a drive request signal from the trigger 30, the electronic processor 42 activates the power switching network 46 to provide power to the motor 18. Through the power switching network 46, the electronic processor 42 controls the amount of electrical current available to the motor 18 and thereby controls the speed and torque output of the motor 18. The power switching network 46 includes a plurality of FETs, for example, a six-FET bridge that receives pulse-width modulated (PWM) signals from the electronic processor 42.

The rotor position sensor 134 is coupled to the electronic processor 42. The rotor positions sensor 134 includes, for example, a plurality of Hall-effect sensors, a quadrature encoder, or the like attached to the motor 18. The rotor position sensor 134 outputs a signal indicative of motor feedback information to the electronic processor 42, such as an indication (e.g., a pulse) when a magnet of a rotor of the motor 18 rotates across the face of a Hall sensor. Based on the motor feedback information from the rotor position sensor 134, the electronic processor 42 can determine the position, velocity, and acceleration of the rotor. In response to the motor feedback information and the signals from the trigger 30, the electronic processor 42 transmits control signals to control the power switching network 46 to drive the motor 18. For instance, by selectively enabling and disabling the FETs of the power switching network 46, power received from the battery pack 22 is selectively applied to the stator windings of the motor 18 in a cyclic manner to cause rotation of the rotor of the motor 18.

In some embodiments, the motor 18 is a sensorless motor that does not include the Hall-effect sensors. Removing the Hall-effect sensors provides the advantage of further reducing the size of the motor package. In these embodiments, the rotor position is detected based on the detecting the current, back electro-motive force (EMF), and/or the like in the inactive phases of the motor 18. Specifically, rather than the Hall sensors, current sensors, voltage sensors, or the like are provided outside the motor 18, for example, in the power switching network 46 or on a current path between the power switching network 46 and the motor 18. The permanent magnets of the rotor 142 generate a back EMF in the inactive phases as the rotor 142 moves past the stator phase coils. The electronic processor 42 detects the back EMF (e.g., using a voltage sensor) or the corresponding current (e.g., using a current sensor) generated in the inactive phase to determine the position of the rotor 142. The motor 18 is then commutated similarly as described above based on the position information of the rotor 142.

The motor feedback information is used by the electronic processor 42 to ensure proper timing of control signals to the power switching network 46 and to provide closed-loop feedback to control the speed of the motor 18 to be at a desired level. Specifically, the electronic processor 42 increases and decreases the duty ratio of the PWM signals provided to the power switching network 46 to maintain the speed of the motor 18 at a speed selected by the trigger 30. For example, as the load on the motor 18 increases, the speed of the motor 18 may decrease. The electronic processor 42 detects the decrease in speed using the rotor position sensor 134 or the back EMF sensors and proportionally increases the duty ratio of the PWM signals provided to the power switching network 46 (and thereby, the electrical power provided to the motor 18) to increase the speed back up to the selected speed. Similarly, when the load on the motor 18 decreases, the speed of the motor 18 may increase. The electronic processor 42 detects the increase in speed using the rotor position sensor 134 or the back EMF sensors and proportionally decreases the duty ratio of the PWM signals provided to the power switching network 46 (and thereby, the electrical power provided to the motor 18) to decrease the speed back down to the selected speed. Such operation of the electronic processor 42 may be continuous when the concrete vibrator 10 is operated.

In open loop speed control, the electronic processor 42 maintains a constant duty ratio of the PWM signals (and thereby, constant electrical power provided to the motor 18) corresponding to the position of the trigger 30.

The electronic processor 42 is operable to receive the sensed position of the rotor 142 and to commutate the electric motor 18 according to the sensed position. Additionally or alternatively, the electronic processor 42 is operable to receive the sensed speed of the rotor 142 and to adjust the amount of power provided to the electric motor 18 in the manner described above such that the motor 18 is driven at a desired speed. In the illustrated embodiment, the desired speed is a speed above 9,000 revolutions per minute. For example, the desired speed may be 10,000 revolutions per minute. As the speed of the electric motor 18 is maintained at the desired speed, a vibration frequency of the vibrator head 28 is also maintained.

It is desired to maintain the vibration frequency of the vibrator head 28 during operation of the concrete vibrator 10. While passing the vibrator head 28 through wet concrete, it is important to vibrate the vibrator head 28 at a speed high enough for proper concrete consolidation. If the speed of the motor 18 drops below a threshold, for example, 9000 revolutions per minute, the concrete will not consolidate properly. Additionally, if the speed of the motor 18 rises above a threshold, for example, 15,000 revolutions per minute, the concrete will not consolidate properly. Thus, the integrity and appearance of the vibrated concrete will be negatively affected if the vibration frequency falls outside a threshold range.

By sensing the speed of the rotor 142 and commutating the electric motor 18 according to the sensed speed, the motor 18 can circumvent any speed discrepancies due to changes in the state of charge of the battery pack 22. As the concrete vibrator 10 is used, the battery pack 22 state of charge becomes depleted. The electronic processor 42 is operable to receive sensed speed of the rotor 142 from the rotor position sensor 134 or the back EMF sensors, and operate commutation of the motor 18 independent of the state of charge of the battery pack 22.

By utilizing the electronic processor 42 and rotor position sensor 134 of the BLDC motor 18, the concrete vibrator 10 has numerous other advantages over other known pencil vibrators 10. First, the concrete vibrator 10 is capable of operating at a higher efficiency when compared to known pencil vibrators. By commutating the motor 18 based on the sensed rotor 142 speed, mechanical drag and friction between components is eliminated. By commutating the motor 18 based on the sensed rotor 142 position, a constant phase advance can be optimized for relatively consistent loading of the tool. This is not possible with brushed DC electric motors. In brushed DC electric motors, brushes wear and the phase advance changes with the brush geometry. As such, the efficiency remains high because the brushless DC motor 18 phase advance is optimized and does not change throughout use.

Second, electromagnetic compatibility (EMC) is reduced with the elimination of EMC caused by brush/bar interaction in traditional motors. This may otherwise have a significant impact for the concrete vibrator 10 because the flexible shaft 26 and the head 28 can function as an antenna receiving undesired electromagnetic compatibility signals.

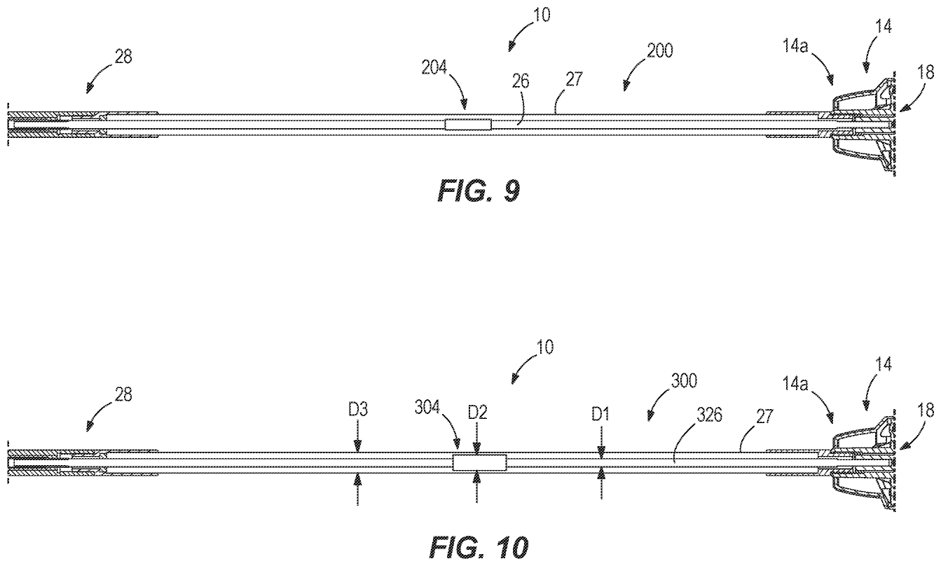

FIG. 9 illustrates the concrete vibrator 10 including another embodiment of a whip assembly 200. The whip assembly 200 is coupled to the motor 18 and the vibrating head 28. The whip assembly 200 includes the shaft 26 and the sheath 27 as previously described. In this embodiment, the shaft 26 is a flexible shaft operable to transfer torque from the motor 18 to the vibrating head 28. The sheath 27 surrounds the shaft 26, and may inhibit damage of the shaft 26.

As illustrated in FIG. 9, the whip assembly 200 is provided with a bushing 204 at an intermediate position along the shaft 26 centrally between the motor housing portion 14a and the vibrator head 28. The bushing 204 may be otherwise located between the motor housing portion 14a and the vibrator head 28. The bushing 204 contacts both the shaft 26 and the sheath 27, and supports the shaft 26 within the sheath 27. The bushing 204 is positioned radially within the interior of the sheath 27 and radially adjacent the exterior of the shaft 26. In some embodiments, the bushing 204 may be a one-piece component. In other embodiments, the bushing 204 may be a multi-piece component such as, without limitation, a ball bearing. A nominal radial clearance exists between the bushing 204 and the shaft 26. thereby supporting the midportion of the shaft 26 for rotation within the sheath 27 while also preventing deflection of the shaft 26 relative to the sheath 27 in a radial direction. The bushing 204 may also inhibit irregular vibration of the shaft 26 by controlling modal shape of vibration of the flexible shaft 26 within the sheath 27. In some embodiments, the bushing 204 is a means to inhibit deflection of the flexible shaft 26 within the sheath 27. In some embodiments, the bushing 204 is also a means to support the shaft 26 within the sheath 27.

FIG. 10 illustrates the concrete vibrator 10 including another embodiment of a whip assembly 300. The whip assembly 300 includes a flexible shaft 326 and the sheath 27. as previously described.

Rather than using a bushing to reduce the radial clearance between the shaft 26 and the sheath 27 as in the whip assembly 200 of FIG. 9, the flexible shaft 26 in the whip assembly 300 includes a stepped diameter portion 304 to reduce the radial clearance between the shaft 326 and the sheath 27. Like the bushing 204, the stepped diameter portion 304 is located at an intermediate position along the shaft 326 centrally between the motor housing portion 14a and the vibrator head 28. The stepped diameter portion 304 may be otherwise positioned along the shaft 326 between the motor housing portion 14a and the vibrator head 28. A majority of (i.e., greater than 50%) the shaft 326 has an outer diameter D1, which nominally corresponds with an inner diameter of the sheath 27. The outer diameter D1 of the shaft 326 is slightly smaller than the inner diameter of the sheath 27 (i.e., the outer diameter D1 of the shaft 326 is nominally less than the inner diameter of the sheath 27) such that a radial gap exists between the outer diameter of the shaft 326 and an inner diameter of the sheath 27. A running clearance is thus provided between the outer diameter D1 of the shaft 326 and the inner diameter of the sheath 27. In the illustrated embodiment, the stepped diameter portion 304 is provided along a minority of the shaft 26 such that the shaft 26 includes a modified outer diameter D2, which is nominally less than an inner diameter of the sheath 27. In the illustrated embodiment, the modified outer diameter D2 is greater than the outer diameter D1 of the remainder of the shaft 326. The sheath 27 further includes an outer diameter D3. In the illustrated embodiment, the outer diameter D3 of the sheath 27 is unchanged at a position radially adjacent the stepped diameter portion 304. In other embodiments, the outer diameter D3 of the sheath 27 adjacent the stepped diameter portion 304 may be enlarged. With regards to the diameters D1, D2, D3, these measurements are exemplary, and do not require the shaft 26 or the sheath 27 to be cylindrical. In other words, the diameters D1, D2, D3 may simply be a dimension of the shaft 26 and/or sheath 27. The stepped diameter portion 304 may inhibit chasing of the shaft 326 within the sheath 27 axially along a direction between the motor housing portion 14a and the vibrator head 28. In some embodiments, the stepped diameter portion 304 is a means to inhibit deflection of the flexible shaft 326 within the sheath 27. In some embodiments, the stepped diameter portion 304 is also a means to support the flexible shaft 326 within the sheath 27.

Although the invention has been described in detail with reference to certain preferred embodiments, variations and modifications exist within the scope and spirit of one or more independent aspects of the invention as described.

Various features and advantages of the invention are set forth in the following claims.

What is claimed is:

1. A concrete vibrator comprising:
a housing having a motor housing portion extending along a longitudinal axis and a handle portion extending transverse to the longitudinal axis and spaced from the motor housing portion, defining an opening between the handle portion and the motor housing portion;
a trigger located within the opening rearward of the motor housing portion, and extending from the handle portion of the housing;
a brushless DC electric motor positioned within the motor housing portion;
a battery pack configured to provide electrical power to the electric motor to drive the motor;
an electronic processor electrically connected with the motor and the battery pack, the electronic processor configured to adjust the electrical power provided to the motor in a closed loop to maintain operation of the motor at a rotational speed set point; and
a vibrator head configured to receive torque from the motor to cause the vibrator head to vibrate.

2. The concrete vibrator of claim 1, wherein the trigger is configured as a variable speed trigger for outputting an electrical signal to the electronic processor proportional to a degree to which the trigger is depressed to vary a rotational speed of the motor.

3. The concrete vibrator of claim 1, wherein the trigger is movable between at least two discrete trigger positions coinciding with different rotational speeds of the motor.

4. The concrete vibrator of claim 3, wherein the trigger is movable between a first operating position in which the motor is driven at a first non-zero desired speed, and a second operating position in which the motor is driven at a second non-zero desired speed different than the first non-zero desired speed.

5. The concrete vibrator of claim 1, further comprising a flexible shaft having a first end coupled to the motor and an opposite, second end coupled to the vibrator head, wherein the flexible shaft is configured to transfer torque from the motor to the vibrator head.

6. The concrete vibrator of claim 1, further comprising a power switching network including a plurality of field-effect transistors that are selectively activated by the electronic processor to control operation of the motor at the rotational speed set point.

7. The concrete vibrator of claim 6, wherein the power switching network includes six field-effect transistors that receive pulse width modulated signals from the electronic processor to selectively apply power to the motor to maintain the motor at the rotational speed set point.

8. The concrete vibrator of claim 1, further comprising a rotor position sensor coupled to the electronic processor, wherein the rotor position sensor is configured to output a signal to the electronic processor indicative of at least one of a position, velocity, or acceleration of the motor.

9. The concrete vibrator of claim 8, wherein the rotor position sensor is a Hall-effect sensor.

10. A concrete vibrator comprising:
a housing including a motor housing portion;
a motor positioned within the motor housing portion;
a power source configured to provide power to the motor; and
a whip assembly coupled at one end to the motor and an opposite end to a vibrator head configured to receive torque from the motor through the whip assembly and cause the vibrator head to vibrate, the whip assembly including
a flexible shaft coupled to the motor,
a sheath surrounding the shaft, and
means to inhibit deflection of the flexible shaft within the sheath.

11. The concrete vibrator of claim 10, wherein the shaft has an outer diameter and the sheath has an inner diameter corresponding to the outer diameter of the shaft, wherein the shaft and the sheath each include a stepped diameter portion along a minority of the whip assembly, wherein the stepped diameter portion has a diameter different than the outer diameter and the inner diameter, and wherein the stepped diameter portion is configured to inhibit deflection of the flexible shaft within the sheath.

12. The concrete vibrator of claim 11, wherein at the stepped diameter portion, the outer diameter of the shaft is nominally larger than the remainder of the shaft and the inner diameter of the sheath is nominally smaller than the remainder of the sheath.

13. The concrete vibrator of claim 11, wherein the shaft and the sheath are circular in cross-sectional shape.

14. The concrete vibrator of claim 10, wherein the whip assembly further includes a bushing positioned between an interior of the sheath and an exterior of the shaft, and wherein the bushing is configured to inhibit deflection of the flexible shaft within the sheath.

15. The concrete vibrator of claim 14, wherein the bushing is positioned at an intermediate position along a length of the shaft between the motor housing and the vibrator head.

16. The concrete vibrator of claim 15, wherein the bushing is positioned centrally along the length of the shaft between the motor housing and the vibrator head.

17. The concrete vibrator of claim 14, wherein a nominal radial clearance exists between the bushing and the shaft, thereby supporting the shaft for rotation within the sheath while also preventing deflection of the shaft relative to the sheath in a radial direction.

18. A method of operating a concrete vibrator, the method comprising:
sensing motor feedback information indicative of a position, velocity, or acceleration of a rotor of an electric motor;
outputting a signal indicative of the motor feedback information to an electronic processor;
based on the motor feedback information, transmitting, by the electronic processor and via closed loop control, electrical current to the motor to maintain operation of the motor at a rotational speed set point; and
transmitting torque from the motor to a vibrator head of the concrete vibrator to cause the vibrator head to vibrate.

19. The method of claim 18, further comprising adjusting the rotational speed set point and an amount of electrical current transmitted to the motor based on input from a variable speed trigger.

20. The method of claim 18, wherein the electrical current is transmitted through a power switching network including a plurality of field-effect transistors that are selectively activated by the electronic processor to control operation of the motor at the rotational speed set point.
